(19) United States
(12) Patent Application Publication
(10) Pub. No.: US 2020/0202276 A1
(43) Pub. Date: Jun. 25, 2020

(54) ORGANIZATION INFORMATION PROCESSING APPARATUS, ORGANIZATION INFORMATION PROCESSING METHOD, AND STORAGE MEDIUM

(71) Applicant: LINK AND MOTIVATION INC., Tokyo (JP)

(72) Inventors: Yoshihisa OZASA, Tokyo (JP); Hideki SAKASHITA, Tokyo (JP)

(21) Appl. No.: 16/720,958

(22) Filed: Dec. 19, 2019

(30) Foreign Application Priority Data
Dec. 20, 2018 (JP) 2018-237849

(51) Int. Cl. G06Q 10/06

(52) U.S. Cl. CPC G06Q 10/06375; G06Q 10/06315; G06Q 10/06393; G06Q 10/06395

(57) ABSTRACT

In order to address a conventional problem that it is not possible to perform processing for properly operating an organization improvement system, an organization information processing apparatus includes: an action information storage unit in which one or more pieces of action information containing one or more scores regarding each of two or more phases constituting an action for an organization improvement are stored; and an improvement processing unit that performs improvement processing, which is processing for an organization improvement, using improvement base information specified from one or more scores of one or more phases among the two or more phases. Accordingly, it is possible to provide processing for properly operating an organization improvement system.

### BACKGROUND OF THE INVENTION

### 1. Field of the Invention

The present invention relates to an organization information processing apparatus and the like for performing processing for an organization improvement.

### 2. Description of Related Art

Conventionally, there is an organization improvement activity assisting system for making findings obtained through a wide variety of organization activities, available for many organizations (see JP 2017-59111A).

This organization improvement activity assisting system includes: a plan information storage part in which, for each plan, a theme matching degree indicating the degree of an effect of the plan for each predetermined stress item, and an organization matching degree in which the suitability of the plan to each content that an organization property, which is an especially specified organization property, may have is quantified as the degree of an influence that is given to the theme matching degree, are stored; a plan proposing part that proposes a plan to an organization based on the information stored in the plan information storage part; an activity log storage part in which two or more activity reports indicating the activity content of an organization that actually performed an activity are stored as activity logs; an activity log analyzing part that determines, for a certain plan, whether or not there is inconsistency in a relationship between the organization property and the effect or a relationship between the theme and the effect indicated by the information stored in the plan information storage part, based on the activity logs stored in the activity log storage part; and a user cooperation part that, in case in which it is determined that there is the inconsistency, gives notice to a predetermined user.

However, according to conventional techniques, it is not possible to perform processing for properly operating an organization improvement system.

### SUMMARY OF THE INVENTION

A first aspect of the present invention is directed to an organization information processing apparatus including: an action information storage unit in which one or more pieces of action information containing one or more scores regarding each of two or more phases constituting an action for an organization improvement are stored; and an improvement processing unit that performs improvement processing, which is processing for an organization improvement, using improvement base information specified from one or more scores of one or more phases among the two or more phases.

With this configuration, it is possible to provide processing for properly operating an organization improvement system, using one or more scores of each of the two or more phases constituting an action for an organization improvement.

Furthermore, a second aspect of the present invention is directed to the organization information processing apparatus according to the first aspect, further including: a response information storage unit in which two or more pieces of response information indicating a response of each of two or more members of the organization to a questionnaire are stored, wherein the improvement processing unit performs processing for an organization improvement, using improvement base information specified from the one or more scores of each of the one or more phases stored in the action information storage unit and the two or more pieces of response information stored in the response information storage unit.

With this configuration, it is possible to provide processing for properly operating an organization improvement system, using one or more scores of each of the two or more phases constituting an action for an organization improvement, and response information of members to a questionnaire.

Furthermore, a third aspect of the present invention is directed to the organization information processing apparatus according to the first or second aspect, wherein the action information has two or more pieces of phase information, which is information in each of the two or more phases, and the phase information has one or more scores and input-related information regarding input in a phase.

With this configuration, it is possible to provide processing for properly operating an organization improvement system, using one or more scores of each of the two or more phases constituting an action for an organization improvement, response information of members to a questionnaire, and input-related information.

Furthermore, a fourth aspect of the present invention is directed to the organization information processing apparatus according to the third aspect, wherein the input-related information is one or more types of information, out of input information input to the phase and input amount information regarding the amount of the input information.

With this configuration, it is possible to provide processing for properly operating an organization improvement system, using one or more scores of each of the two or more phases constituting an action for an organization improvement, response information of members to a questionnaire, and input-related information.

Furthermore, a fifth aspect of the present invention is directed to the organization information processing apparatus according to any one of the first to fourth aspects, wherein the one or more pieces of action information in the action information storage unit respectively correspond to organization attribute values, each of which is an attribute value of the organization, and the improvement processing unit performs different types of processing for an organization improvement, according to the organization attribute values, even in a case of using same improvement base information.

With this configuration, it is possible to provide proper processing for properly operating an organization improvement system, according to an attribute value of the organization.

Furthermore, a sixth aspect of the present invention is directed to the organization information processing apparatus according to any one of the first to fifth aspects, wherein the action information contains a score of one or more of the expectation level and the satisfaction level for each phase.

With this configuration, it is possible to provide processing for properly operating an organization improvement system, using a score of one or more of the expectation level and the satisfaction level in each of the two or more phases constituting an action for an organization improvement.

Furthermore, a seventh aspect of the present invention is directed to the organization information processing apparatus according to any one of the first to sixth aspects, further including: a proposal information storage unit in which each of two or more pieces of proposal information indicating a proposal regarding an operation of an organization improvement system, which is a system for an organization improvement, is stored in association with an improvement base information condition, which is a condition regarding improvement base information containing one or more scores of any one or more phases, wherein the improvement processing unit includes: a proposal information acquiring part that acquires proposal information paired with an improvement base information condition matching the improvement base information, from the proposal information storage unit; and a proposal information output part that outputs the proposal information acquired by the proposal information acquiring part.

With this configuration, it is possible to make a proposal for properly operating an organization improvement system, using one or more scores of each of the two or more phases constituting an action for an organization improvement.

Furthermore, an eighth aspect of the present invention is directed to the organization information processing apparatus according to any one of the first to seventh aspects, further including: a setting information storage unit in which one or more pieces of setting information, which is information that is used by an organization improvement system, are stored in association with an improvement base information condition, which is a condition regarding improvement base information containing one or more scores of any one or more phases, wherein the improvement processing unit includes: a setting information acquiring part that acquires setting information paired with an improvement base information condition matching the improvement base information, from the setting information storage unit; and a setting information output part that outputs the setting information acquired by the setting information acquiring part.

With this configuration, it is possible to provide setting information for properly operating an organization improvement system, using one or more scores of each of the two or more phases constituting an action for an organization improvement.

Furthermore, a ninth aspect of the present invention is directed to the organization information processing apparatus according to any one of the first to eighth aspects, wherein, in the action information storage unit, action information is stored for each organization, and action information of the entire organization and action information of each of two or more departments, in each of at least one or more organizations, are stored, and the improvement processing unit acquires one or more scores contained in the action information of the entire organization and performs processing for an organization improvement using improvement base information having the one or more scores, and acquires one or more scores contained in the action information of each of the two or more departments and performs processing for an organization improvement using improvement base information having the one or more scores.

With this configuration, it is possible to provide processing for properly implementing an operation process of the entire organization and an operation process of each of one or more departments of the organization.

With the organization information processing apparatus according to the present invention, it is possible to provide processing for properly operating an organization improvement system.

### BRIEF DESCRIPTION OF THE DRAWINGS

FIG. 1 is a conceptual diagram of an information system A in Embodiment 1.

FIG. 2 is a block diagram of the information system A in the embodiment.

FIG. 3 is a flowchart illustrating an operation example of an organization information processing apparatus 1 in the embodiment.

FIG. 4 is a flowchart illustrating an example of improvement processing in the embodiment.

FIG. 5 is a flowchart illustrating an example of setting information using processing in the embodiment.

FIG. 6 shows an item information management table in the embodiment.

FIG. 7 shows an organization information management table in the embodiment.

FIG. 8 shows action information in the embodiment.

FIG. 9 shows response information in the embodiment.

FIG. 10 shows an individual score table in the embodiment.

FIG. 11 shows a proposal information management table in the embodiment.

FIG. 12 shows a setting information management table in the embodiment.

FIG. 13 shows an output example in the embodiment.

FIG. 14 is a schematic view of a computer system in the embodiment.

FIG. 15 is a block diagram of the computer system in the embodiment.

### DETAILED DESCRIPTION OF THE INVENTION

Hereinafter, an embodiment of an organization information processing apparatus and the like will be described with reference to the drawings. It should be noted that constituent elements denoted by the same reference numerals in the embodiments perform similar operations, and thus a description thereof may not be repeated.

### Embodiment 1

In this embodiment, an organization information processing apparatus that manages an operation process of a system for assisting an action for an organization improvement, wherein a score of each of two or more phases is stored and improvement processing for improving an operation is performed according to the score, and an information system including the organization information processing apparatus will be described.

Furthermore, in this embodiment, an information system will be described including an organization information processing apparatus in which a result of a survey to an organization is also stored and improvement processing is performed according to the result and the score.

Furthermore, in this embodiment, an information system will be described including an organization information processing apparatus in which an input situation in one or more phases in an operation process is stored and improvement processing is performed according to the input situation as well.

Furthermore, in this embodiment, an information system will be described including an organization information processing apparatus in which one or more attribute values of an organization is also managed and different types of improvement processing are performed according to the one or more attribute values.

In this embodiment, the improvement processing is, for example, output of a proposal regarding an operation, automatic correction of setting information regarding an operation, or the like.

Moreover, in this embodiment, an operation process that is managed is an operation process of the entire organization, and an operation process of each of one or more departments constituting the organization.

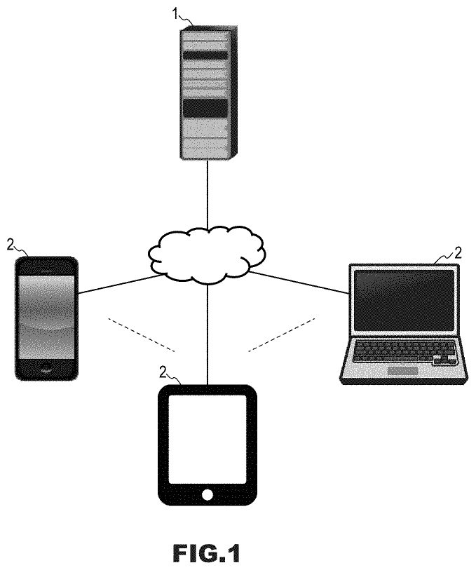

FIG. 1 is a conceptual diagram of an information system A in this embodiment. The information system A includes an organization information processing apparatus 1 and one or at least two terminal apparatuses 2. The organization information processing apparatus 1 in this example is a so-called server apparatus. The organization information processing apparatus 1 is, for example, a cloud server or an ASP server, and there is no limitation on the type or installation location thereof. Each terminal apparatus 2 is a mobile terminal such as a smartphone, a tablet device, or a mobile phone, a so-called personal computer, or the like, and there is no limitation on the type thereof.

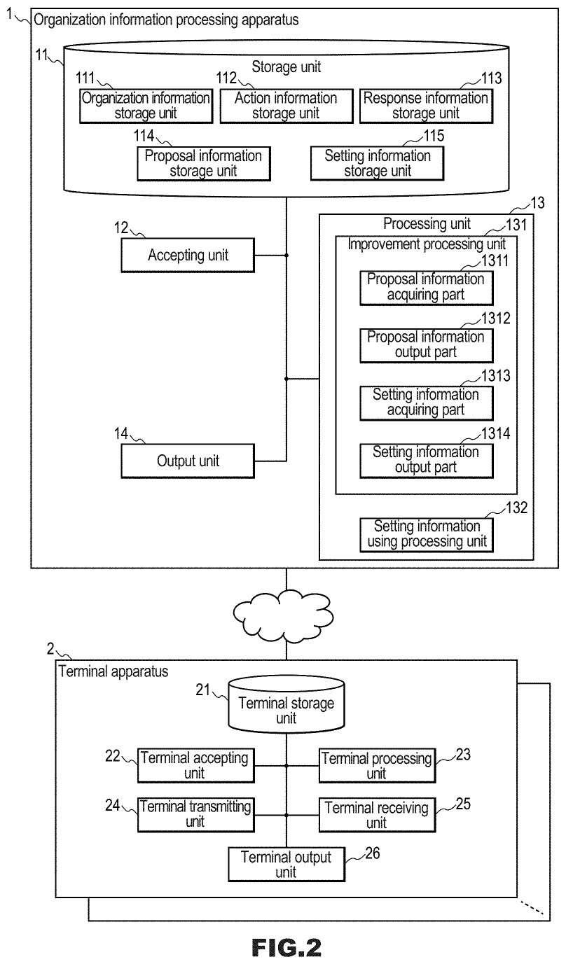

FIG. 2 is a block diagram of the information system A in this embodiment. The organization information processing apparatus 1 includes a storage unit 11, an accepting unit 12, a processing unit 13, and an output unit 14.

The storage unit 11 includes an organization information storage unit 111, an action information storage unit 112, a response information storage unit 113, a proposal information storage unit 114, and a setting information storage unit 115.

The processing unit 13 includes an improvement processing unit 131 and a setting information using processing unit 132. The improvement processing unit 131 includes a proposal information acquiring part 1311, a proposal information output part 1312, a setting information acquiring part 1313, and a setting information output part 1314.

The terminal apparatus 2 includes a terminal storage unit 21, a terminal accepting unit 22, a terminal processing unit 23, a terminal transmitting unit 24, a terminal receiving unit 25, and a terminal output unit 26.

In the storage unit 11 constituting the organization information processing apparatus 1, various types of information are stored. The various types of information are, for example, later-described organization information, later-described action information, later-described response information, later-described proposal information, and later-described setting information.

In the organization information storage unit 111, two or more pieces of organization information are stored. The organization information is information regarding an organization. The organization information has, for example, an organization identifier. The organization identifier is an organization name, an ID for identifying an organization, or the like. The organization identifier is, for example, a company name, a sector name, or the like.

The organization information contains, for example, one or at least two organization attribute values and one or at least two pieces of member information. Each organization attribute value is a value of an attribute of an organization. The organization attribute value is, for example, an industry type identifier indicating an industry type of an organization (e.g., bank, apparel, manufacturer, etc.), a size identifier for classifying a size of an organization (e.g., large enterprise, small-to-medium sized enterprise, micro enterprise, self-employed, etc.), information indicating a category of an organization based on business conditions of an organization (e.g., in the black, in the red, etc.), a region identifier indicating the region of a home office, a sector identifier for identifying a sector in an organization (e.g., human-resources, accounting, laboratory, engineering division, sales division, manufacturing division, etc.), a listing identifier indicating whether or not an organization is listed, a stage identifier indicating a stage of an organization (e.g., founding period, expansion period, diversification period, revitalization period, etc.), a business model identifier indicating a business model (e.g., innovator business that performs multiple types of businesses, professional business that performs a small number of businesses such as one business and depends on people, operator business that performs a small number of businesses such as one business and depends on systems, etc.), the number of members, an organization identifier of a lower organization, the number of lower organizations, the years after establishment, capital, revenue, whether or not the organization is in the black, profit, or the like. The industry type may be rough classification such as financing company, manufacturer, trading company, service industry, or the like, or fine classification such as bank, securities company, electronics manufacturer, food manufacturer, machine manufacturer, or the like. It will be appreciated that there is no limitation on how to classify industry types and the like.

The member information is information on an organization member. The member is, for example, an employee of a company, a staff member of a school, a staff member of a government office, or the like, but may also include an executive of a company and the like. The member may be a non-regular worker or the like.

Furthermore, the member information has, for example, a member identifier. The member identifier is, for example, a name, an ID, or the like of a member. The member information has one or more member attribute values. Each member attribute value is a value of an attribute of a member. The member attribute value is, for example, the length of service, the age, the sex, an evaluation value of a member (e.g., five grade evaluation of 1 to 5, three grade evaluation of A, B, and C, etc.), an evaluation value (e.g., five grade evaluation of 1 to 5, three grade evaluation of A, B, and C, etc.) of each property of a member (e.g., cooperativity job performing ability, originality etc.), an organization identifier of an organization to which a member belongs, or the like. The member information may also contain evaluation values of a member at two or more points in time. The member information may be regarded as containing member information of a manager, or the member information of a manager may be regarded as a different type of information from member information of a non-manager.

The organization information may have, for example, one or more pieces of setting information that are used by the organization to operate the system. The setting information is information that is used by an organization improvement system. The setting information may also be said to be a parameter. The information that is used by an organization improvement system is typically information that is used by an organization improvement system to exert the functions. The setting information is, for example, survey frequency information, function specifying information for specifying a function that is used in an organization improvement system, survey specifying information for specifying a survey that is to be implemented (e.g., a parameter indicating whether or not to implement a focus survey), or a parameter indicating whether or not to implement an organization diagnosis.

The survey is a so-called research, and may be for example, questionnaires to members and statistical processing on responses, or the like. The survey may be of, for example, two types or more such as “organization diagnosis” or “focus survey”.

“Organization diagnosis” is, for example, information indicating that a questionnaire having questions of both a later-described overall item and a later-described individual item is to be implemented. “Organization diagnosis” may also be said to be an “engagement survey”. The focus survey is, for example, information indicating that a questionnaire having questions of only a later-described overall item is to be implemented. The engagement survey is a survey for calculating an engagement score. The focus survey is a survey that is simpler than an engagement survey, and is a survey with a narrower focus.

Furthermore, the survey frequency information is information regarding a frequency at which a survey is implemented. The survey frequency information is, for example, “every month”, “four times per year”, “every quarter”, “once per year”, “April, October”, or the like. That is to say, the survey frequency information is information indicating the number of times that a survey is implemented during a certain period of time, the period in which a survey is implemented, the date at which a survey is implemented, or the like. The survey frequency information is, for example, information regarding a frequency at which a focus survey is implemented, information regarding a frequency at which an engagement survey is implemented, or information regarding a frequency at which a questionnaire is implemented.

Also, the function specifying information is, for example, information for specifying whether or not to use a survey function (whether or not to implement a survey), or information for specifying whether or not to use an action plan (whether or not to register an action plan). The action plan is a plan of an action based on a result of a survey, and is a plan for improving an organization.

Furthermore, the survey specifying information is, for example, information indicating whether or not to implement a first survey, or information indicating whether or not to implement a second survey. The first survey is, for example, a focus survey. The second survey is, for example, an engagement survey.

Furthermore, the organization improvement system may be the organization information processing apparatus 1, the information system A, or other apparatuses.

Furthermore, the organization information may have, for example, one or more pieces of transmission destination information. The transmission destination information is information for specifying a destination to which information is to be transmitted. The transmission destination information is, for example, an e-mail address, a telephone number, an app ID, an IP address, or the like.

In the action information storage unit 112, one or more pieces of action information are stored. The action information is information regarding an action for an organization improvement. The action is an action for an organization improvement. The action is user's input or operation to the organization information processing apparatus 1, or user's input or operation to another organization improvement system. The user is a user who is trying to improve an organization. The input or operation to the organization information processing apparatus 1 also includes a case in which input or operation to the terminal apparatus 2 is received by the organization information processing apparatus 1. The input or operation to another organization improvement system also includes a case in which input or operation to the terminal apparatus 2 is received by the organization information processing apparatus 1.

It is preferable that action information for each organization is stored in the action information storage unit 112. It is preferable that action information of the entire organization and action information of each of the one or at least two department are stored in the action information storage unit 112 for each of at least one or more organizations.

The action information contains two or more scores. The two or more scores are respectively scores regarding two or more phases constituting an action for an organization improvement. Each phase is, for example, a phase constituting a process for an organization improvement. The phase is, for example, “See”, “Plan”, “Do”, or “Check-Action”. The phase is, for example, “See”, “Plan”, or “Do/Check-Action”. The phase is, for example, “Plan”, “Do”, “Check”, or “Action”. The phase is, for example, “Plan”, “Do”, or “Check-Action”.

“See” is a phase of seeing a state of an organization. “Plan” is a phase of, after seeing the state in “See”, laying out a plan for an organization improvement. “Do” is a phase of implementing the plan for the organization improvement. “Check” is a phase of checking a result of the implementation for the organization improvement. “Action” is a phase of performing an action based on a result of the check.

The score regarding each phase is typically information input by a user, but may also be automatically calculated information. If the score is automatically calculated information, for example, a later-described processing unit 13 performs calculation based on information input by a user.

Furthermore, the score contained in the action information contains, for example, scores of one or two types of the expectation level and the satisfaction level. The score contained in the action information is, for example, scores of one or more types of expectation levels in two or more phases and satisfaction levels in two or more phases. The expectation level is a level of expectation to an object (e.g., company, job, supervisor, workplace, influence in the field, salary, etc.). It will be appreciated that “Expectation level” may be regarded having a similar meaning as a term such as “importance level” or “influence level”, and may be replaced by these similar terms. The satisfaction level is a level of satisfaction with an object (e.g., company, job, supervisor, workplace, influence in the field, salary etc.). It will be appreciated that “Satisfaction level” may be regarded having a similar meaning as a term such as “realization level” or “achievement level”, and may be replaced by these similar terms.

The action information typically corresponds to an organization identifier. The action information may also contain an organization identifier. The action information typically has two or more pieces of phase information. The phase information is information regarding each of the two or more phases. The phase information has, for example, a phase identifier for identifying a phase and one or more pieces of score information. The phase information has, for example, a phase identifier, one or more pieces of score information, and input-related information. The score information has, for example, an identifier of an object for which a score is acquired, and a score. The input-related information contains one or two types of information, of input information input to the phase and input amount information regarding the amount of the input information. The input information may be regarded as containing a score.

In the response information storage unit 113, two or more pieces of response information are stored. The response information is information indicating a response to a question to one or at least two members of an organization. The question may also be said to be a topic or an item. The response information may be simply said to be a response.

Furthermore, the response information is typically associated with an organization identifier for identifying an organization. The response information is typically associated with an organization attribute value, which is one or more attribute values of an organization.

One piece of response information is a group of information on responses from one or at least two members of one organization. One piece of response information has two or more pieces of member response information respectively corresponding to two or more members. The member response information is information containing a response of a member to a question for an item. The member response information has two or more pieces of item response information. The number of pieces of item response information contained in the member response information is typically the same as the number of items. The item response information has an item identifier and response information. The response information is information regarding a response to a question. The response information has, for example, satisfaction level information. The satisfaction level information is information indicating a response regarding a satisfaction level of a member to an item. The satisfaction level information is, for example, information for specifying a satisfaction level to an item. The satisfaction level information is classified into two or more classes. The satisfaction level information may take, for example, any natural number of 1 to 5. Note that the satisfaction level information may be, for example, an evaluation value, such as A, B, and C, having the rank or order, or may be any natural number of 1 to 100, for example. The response information has, for example, satisfaction level information and expectation level information. The expectation level information is information indicating a response regarding an expectation level of a member to an item. The expectation level information is, for example, information for specifying an expectation level to an item. The expectation level information is classified into two or more classes. The expectation level information may take, for example, any natural number of 1 to 5. Note that the expectation level information is, for example, an evaluation value, such as A, B, and C, having the rank or order, or may be any natural number of 1 to 100, for example. There is no limitation on the content of an item, a question, and the like. The member is, for example, an employee of a company, a staff member of a school, a staff member of a government office, or the like, but may also include an executive of a company and the like. The member may be a non-regular worker.

The overall item is, for example, a company satisfaction level indicating a level of being satisfied with a company, a job satisfaction level indicating a level of being satisfied with a job, a supervisor satisfaction level indicating a level of being satisfied with a supervisor, a workplace satisfaction level indicating a level of being satisfied with a workplace, or the like. The individual item is, for example, a business superiority of a company, transmission and transfer of a strategic objective, a sense of overall solidarity, validity of evaluation and salary, or the like.

In the proposal information storage unit 114, two or more pieces of proposal information are stored. The proposal information is typically associated with improvement base information condition. The proposal information is information indicating a proposal regarding an operation of an organization improvement system, which is a system for an organization improvement. The organization improvement system may be the organization information processing apparatus 1, the information system A, or other apparatuses. The operating may also be said to be using or utilizing.

The improvement base information condition is a condition regarding improvement base information containing one or more scores of any one or more phases. The improvement base information in this example is information based on which proposal information is acquired. The improvement base information is preferably one or at least two types of information, of one or more scores of one or more phases, input-related information, and organization attribute values. There is no limitation on the description method of the improvement base information condition. The improvement base information condition may be an operation expression, a program (a function or a method), or the like.

The improvement base information condition is, for example, “the expectation level in a specific phase is high enough to satisfy a condition (e.g., is greater than or equal to a threshold or is greater than the threshold)”, “the satisfaction level in a specific phase is low enough to satisfy a condition (e.g., is less than or equal to a threshold or is less than the threshold)”, “the expectation level in a specific phase is high enough to satisfy a condition and the satisfaction level in a specific phase is low enough to satisfy a condition”. The specific phase is, for example, “DO” or “Check”. The improvement base information condition is, for example, “the satisfaction level of a specific item contained in the response information is low enough to satisfy a condition (e.g., is less than or equal to a threshold or is less than the threshold)”. The satisfaction level of a specific item contained in the response information is, for example, a level of being satisfied with a supervisor, or a level of being satisfied with a company. The improvement base information condition is, for example, “a situation of responses of members of one organization is not good enough to satisfy a predetermined condition”. “Situation of responses of members of one organization is not good enough to satisfy a predetermined condition” is, for example, a state in which the number of pieces of member response information contained in the response information corresponding to one organization is less than or equal to a threshold or is less than the threshold, or a state in which the ratio of the number of pieces of member response information contained in the response information corresponding to one organization, with respect to the number of members, is less than or equal to a threshold or is less than the threshold. The situation of a response is, for example, one or at least two of the ratio of responses, the number of responses, and the content of responses.

The number of members of one organization is, for example, stored in the organization information storage unit 111, but there is no limitation on the method for acquiring the number. The improvement base information condition is, for example, “the frequency of a survey indicated by the survey frequency information corresponding to one organization is high enough to satisfy a predetermined condition, and a situation of responses of members of the one organization is not good enough to satisfy a predetermined condition”.

Furthermore, the survey frequency information of one organization is, for example, information that is stored in the organization information storage unit 111, or that can be acquired from information (e.g., one or more pieces of information for specifying an implementation time to implement a survey) stored in the organization information storage unit 111. The survey frequency information of one organization is typically stored in association with an organization identifier.

In the setting information storage unit 115, one or more pieces of setting information are stored. The setting information in this example is typically associated with an improvement base information condition. The setting information in this example is typically setting information itself, but may also be setting information change information for changing the setting information. The setting information change information is, for example, an operation expression having, as a parameter, setting information that is used to operate the system, information indicating that the frequency of a survey is to be lowered to half the current frequency, or the like.

The improvement base information condition is a condition regarding improvement base information. The improvement base information is information based on which setting information is acquired. The improvement base information is preferably one or at least two types of information, of one or more scores of one or more phases, input-related information, and organization attribute values.

The improvement base information condition is, for example, “the expectation level in a specific phase is high enough to satisfy a condition”, “the satisfaction level in a specific phase is low enough to satisfy a condition”, or “the expectation level in a specific phase is high enough to satisfy a condition and the satisfaction level in a specific phase is low enough to satisfy a condition”. The improvement base information condition is, for example, “the satisfaction level of a specific item contained in the response information is low enough to satisfy a condition”. The satisfaction level of a specific item contained in the response information is, for example, a level of being satisfied with a supervisor, or a level of being satisfied with company. The improvement base information condition is, for example, “a situation of responses of members of one organization is not good enough to satisfy a predetermined condition”. “Situation of responses of members of one organization is not good enough to satisfy a predetermined condition” is, for example, a state in which the number of pieces of member response information contained in the response information corresponding to one organization is less than or equal to a threshold or is less than the threshold, or a state in which the ratio of the number of pieces of member response information contained in the response information corresponding to one organization, with respect to the number of members, is less than or equal to a threshold or is less than the threshold.

The accepting unit 12 accepts various types of information, instructions, or the like. In this example, the accepting is typically receiving from the terminal apparatus 2, but may be regarded as a concept that encompasses, for example, accepting information input from an input device such as a keyboard, a mouse, or a touch panel, accepting information read from a storage medium such as an optical disk, a magnetic disk, or a semiconductor memory, and the like.

The various types of information, instructions, or the like are, for example, organization information, action information, questionnaire response information, proposal information, setting information, later-described input information, a start instruction, or the like. The start instruction is an instruction to start an operation.

The processing unit 13 performs various types of processing. The various types of processing are, for example, the processes that are performed by the improvement processing unit 131, the setting information using processing unit 132, the proposal information acquiring part 1311, the proposal information output part 1312, the setting information acquiring part 1313, and the setting information output part 1314.

The various types of processing are, for example, a process that accumulates the various types of information accepted by the accepting unit 12, in the storage unit 11. The processing unit 13 accumulates, for example, the organization information accepted by the accepting unit 12, in the organization information storage unit 111. The processing unit 13 accumulates, for example, the action information accepted by the accepting unit 12, in the action information storage unit 112. The processing unit 13 accumulates, for example, the response information accepted by the accepting unit 12, in the response information storage unit 113. The processing unit 13 accumulates, for example, the input information accepted by the accepting unit 12, in the action information storage unit 112.

The processing unit 13 may, for example, calculate a score of each organization, using the response information of the organization. The processing unit 13 calculates a score, for example, as follows.

The processing unit 13 performs statistical processing on response information for two or more items, the number of which being the same as the number of members, thereby acquiring an item score for each organization and for each item. The item score is a score for each item (each question in a questionnaire).

For example, the processing unit 13 performs, for each organization, statistical processing on the satisfaction level information for each of the two or more items contained in the response information of the organization, thereby acquiring an item score for each organization and for each item. The processing unit 13 may calculate, for example, a (e.g., an average value or a median value) representative value of the satisfaction level information for each organization and for each item, and accumulate the representative value as an item score in an unshown buffer or the storage unit 11 so as to be paired with the item identifier. The satisfaction level information is information for specifying a satisfaction level.

Furthermore, for example, the processing unit 13 may, for each organization and for each item, perform different weighting according to a member's attribute value, calculate a weighted average value of the satisfaction level, and accumulate the weighted average value as an item score in an unshown buffer or the storage unit 11 so as to be paired with the item identifier. The member's attribute value is, for example, the position, the length of service, the sex, or the like. For example, the processing unit 13 may calculate a weighted average value while making the weight of the satisfaction level information of a long-service employee greater than that of a short-service employee.

The processing unit 13 acquires item scores of at least some of the items for each organization, using the satisfaction level information and the expectation level information. The item for which an item score is acquired using the satisfaction level information and the expectation level information is, for example, an individual item. The expectation level information is information for specifying an expectation level.

It is preferable that the processing unit 13 acquires an item score, for example, such that the higher the satisfaction level information is, the higher the score is, and such that the lower the expectation level information is, the higher the score is.

The processing unit 13 calculates, for example, for each of the two or more organizations and for each of the two or more items, a representative value of the satisfaction level information contained in the response information and a representative value of the expectation level information contained in the response information, and acquires an item score for each item using the two representative values.

The processing unit 13 may, for example, apply the satisfaction level information and the expectation level information to the individual score table, thereby acquiring an item score for each item. The processing unit 13 may, for example, apply a statistical processing result of the satisfaction level information and a statistical processing result of the expectation level information to the individual score table, thereby acquiring an item score for each item. The processing unit 13 may, for example, apply a representative value of the satisfaction level information and a representative value of the expectation level information to the individual score table, thereby acquiring an item score for each item. The processing unit 13 may, for example, apply a weighted average value of the satisfaction level information and a weighted average value of the expectation level information to the individual score table, thereby acquiring an item score for each item. The weighted average value is a weighted average value based on a member's attribute value. The individual score table in this example is information in which, if satisfaction level information and expectation level information are given, an item score is decided on. The individual score table in this example is, for example, a table having an axis of satisfaction level information and an axis of expectation level information, wherein table cells respectively show individual scores, so that, if satisfaction level information and expectation level information are decided on, an item score is decided on. This individual score table is preferably a table in which the larger the satisfaction level indicated by the satisfaction level information is, the larger the acquired item score is, and the smaller the expectation level indicated by the expectation level information is, the larger the acquired item score is.

The processing unit 13 may, for example, calculate an item score for each item, using a function that is an increasing function having, as a parameter, a representative value of the satisfaction level information, and is a decreasing function having, as a parameter, a representative value of the expectation level information.

In the description above, the process in which the processing unit 13 calculates a so-called absolute item score was described. The absolute item score is an item score that does not depend on an organization identifier such as the industry type, and is acquired typically only from response information corresponding to organization identifier of one organization.

Note that it is also possible that the processing unit 13 calculates a so-called relative item score. That is to say the processing unit 13 acquires, for example, an item score according to an organization attribute value. In this case, the processing unit 13 calculates, for example, an absolute item score of each item of the organization. Then, the processing unit 13 calculates, for example, a relative item score, using one or more item scores acquired from response information corresponding to one or more organization identifiers paired with the same organization attribute value (e.g., the same industry type) as the organization attribute value of the organization.

The processing unit 13 calculates, for example, a deviation of the absolute item score of the organization, using an item score of an organization identified with one or more organization identifiers paired with the same organization attribute value as that of the organization. Techniques for calculating a relative item score, which is a deviation of one absolute item score, using multiple absolute item scores are well known.

Furthermore, the processing unit 13 may, for example, calculate an average value of two or more absolute item scores acquired from response information corresponding to one or more organization identifiers paired with the same organization attribute value as that of the organization, and acquire a relative item score, using a difference between the average value and the absolute item score of the organization. This relative item score may be a difference itself between an average value of item scores and the absolute item score of the organization, or may be a value calculated by substituting this difference as a parameter for an operation expression.

That is to say, there are various conceivable methods for calculating a relative item score of one organization, using absolute item scores of multiple organizations corresponding to the same organization attribute value. The same organization attribute value means that one or at least two organization attribute values are the same. The processing unit 13 may, for example, calculate a relative item score of a company of interest among multiple companies of the same industry type, or may calculate a relative item score of a company of interest among multiple companies within a category of the same industry type and with a similar size, for each item.

The processing unit 13 acquires an overall score for two or more pieces of organization response information, using two or more item scores. The overall score is an overall score of an organization. Typically the higher each of the two or more item scores is, the higher the overall score acquired by the processing unit 13 is.

The processing unit 13 acquires an attribute value-considering overall score, which is a score of an organization identified with an organization identifier contained in an output instruction, and is a score of the organization according to one or at least two organization attribute values paired with the organization identifier, using multiple pieces of organization response information.

That is to say, the processing unit 13 may, for example, acquire an attribute value-considering overall score, which is a relative overall score of one organization, among multiple organizations matching the condition configured using one or at least two organization attribute values. For example, the processing unit 13 may, for example, acquire an attribute value-considering overall score of “laboratory+engineering division” of A company, which is a manufacturer, from the response information of employees belonging to a laboratory or an engineering division of a specific organization (e.g., A company), among multiple organizations with the type identifier “manufacturer” and the sector identifier “laboratory or engineering division”. In this case, the condition is “(industry type identifier=manufacturer) AND (sector identifier=laboratory OR engineering division)”. The processing unit 13 acquires, for example, an absolute overall score, using two or more absolute item scores.

Furthermore, the processing unit 13 acquires, for example, an attribute value-considering overall score, which is a relative overall score, using two or more relative item scores.

The processing unit 13 preferably acquires an overall score, using both an overall item score of an item and an individual item score of the item while making the weight of overall item scores of items greater than that of individual item scores of the items. Also in this case, the processing unit 13 can acquire an absolute overall score, using an absolute item score. Also, the processing unit 13 can acquire an attribute value-considering overall score, using a relative item score.

The processing unit 13 may, for example, calculate an overall score, using the equation “overall score=α×statistical score of overall item scores of items+β×statistical score of individual item scores of items”. In this example, it is preferable that (α>β). That is to say the processing unit 13 preferably acquires an overall score while making the weight of overall item scores of items greater than that of individual item scores of the items. For example, “α=0.7, β=0.3”. The statistical score of overall item scores of items is, for example, an average value, a weighted average value, or the like of overall item scores of items. statistical score of individual item scores of items is, for example, an average value, a weighted average value, or the like of individual item scores of items.

The processing unit 13 acquires an overall score and an organization attribute value paired with an organization identifier, and acquires an attribute value-considering overall score, which is a score of an organization according to the organization attribute value, using the overall score and the organization attribute value. The attribute value-considering overall score may be regarded as a relative overall score that depends on an organization attribute value. Also, the attribute value-considering overall score may also be said to be a relative engagement score. The organization attribute value in this case is one or at least two organization attribute values.

The processing unit 13 acquires, for example, an attribute value-considering overall score, which is a score of an organization identified with an organization identifier, and is a score of the organization according to an organization attribute value paired with the organization identifier, using multiple pieces of organization response information.

The processing unit 13 acquires an overall score and an organization attribute value paired with an organization identifier, and acquires an attribute value-considering overall score, using the overall score and the organization attribute value. The overall score in this example is an absolute overall score, and the attribute value-considering overall score is a relative overall score.

The processing unit 13 acquires an attribute value-considering overall score, using the acquired two or more relative item scores. Typically, the higher the relative item score is, the higher the attribute value-considering overall score acquired by the processing unit 13 is. The processing unit 13 acquires, for example, an attribute value-considering overall score, using an increasing function (e.g., an average value, a weighted average value, a sum, etc.) having, as a parameter, the acquired two or more relative item scores. For example, a correspondence table of groups of two or more relative item scores and attribute value-considering overall scores is stored in the storage unit 11, and, referring to the correspondence table, the processing unit 13 acquires an attribute value-considering overall score corresponding to the acquired two or more relative item scores, from the correspondence table.

The improvement processing unit 131 performs improvement processing. The improvement processing is processing for an organization improvement. The improvement processing unit 131 performs improvement processing, using improvement base information. The improvement processing is, for example, a process that outputs the proposal information, or a process that outputs the setting information. The process that outputs the proposal information is, for example, a process that transmits the proposal information to the terminal apparatus 2. The process that outputs the setting information is, for example, a process that accumulates the setting information in the organization information storage unit 111 or an external apparatus.

The improvement processing unit 131 performs improvement processing, which is processing for an organization improvement, using improvement base information specified using one or more scores of one or more phases, of the two or more phases. There is no limitation on the method, apparatus, and the like for acquiring improvement base information.

The improvement processing unit 131 performs improvement processing, using improvement base information specified using one or more scores of each of the one or more phases stored in the action information storage unit 112 and two or more pieces of response information stored in the response information storage unit 113. There is no limitation on the method, apparatus, and the like for acquiring improvement base information. It will be appreciated that, in this example, one or more scores and two or more pieces of response information are information associated with the same organization identifier.

The improvement processing unit 131 acquires, for example, one or at least two scores of any one or at least two phases, of the two or more phases, from the action information storage unit 112, and performs improvement processing, which is processing for an organization improvement, using improvement base information having the one or more scores.

The improvement processing unit 131 acquires, for example, one or at least two scores of each of the one or more phases from the action information storage unit 112, acquires two or more pieces of response information from the response information storage unit 113, and performs processing for an organization improvement, using improvement base information having the one or more scores of each of the two or more phases and the two or more pieces of response information.

The improvement processing unit 131 preferably performs different types of processing for an organization improvement, according to the organization attribute values, even in the case of using same improvement base information. That is to say, the improvement processing unit 131 preferably performs different types of improvement processing, according to the organization attribute values (e.g., the industry type or the organization size). The different types of processing may be outputting different types of proposal information, or outputting different types of setting information. The different types of processing may be, for example, outputting proposal information to an organization corresponding to a first organization attribute value, outputting setting information to an organization corresponding to a second organization attribute value, and outputting proposal information and outputting setting information to an organization corresponding to a third organization attribute value.

The improvement processing unit 131 acquires, for example, one or at least two scores contained in the action information of the entire organization and performs organization improvement processing using improvement base information having the one or more scores, and acquires one or at least two scores contained in the action information of each of the two or more departments and performs organization improvement processing using improvement base information having the one or more scores. In this case, for example, an organization has two or more departments.

In this example, the output is typically transmission to the terminal apparatus 2, but may be regarded as a concept that encompasses display on a display screen, projection using a projector, printing by a printer, output of a sound, accumulation in a storage medium, delivery of a processing result to another processing apparatus or another program, and the like.

The proposal information acquiring part 1311 acquires proposal information paired with an improvement base information condition matching the improvement base information, from the proposal information storage unit 114.

The proposal information output part 1312 outputs the proposal information acquired by the proposal information acquiring part 1311. In this example, the output is typically transmission to the terminal apparatus 2, but may be regarded as a concept that encompasses display on a display screen, projection using a projector, printing by a printer, output of a sound, accumulation in a storage medium, delivery of a processing result to another processing apparatus or another program, and the like.

The setting information acquiring part 1313 acquires setting information paired with an improvement base information condition matching the improvement base information, from the proposal information storage unit 114.

The setting information output part 1314 outputs the setting information acquired by the proposal information acquiring part 1311. In this example, the output is typically accumulation, but may also be transmission to the terminal apparatus 2 or another apparatus. The accumulation destination of the setting information is, for example, the organization information storage unit 111, but may also be another apparatus.

The setting information using processing unit 132 performs processing, using the setting information stored in the setting information storage unit 115. The setting information using processing unit 132 transmits, for example, notice to prompt a user to implement a survey to one or more terminal apparatuses 2, at the time specified with the setting information. The setting information using processing unit 132 transmits, for example, information on a questionnaire for survey implementation, to one or more terminal apparatuses 2, at the time specified with the setting information. For example, if the setting information is “information indicating that a focus survey is not to be implemented”, the setting information using processing unit 132 changes an interface such that access to a screen for a focus survey is not permitted or a screen for a focus survey cannot be accessed. The setting information using processing unit 132 does not permit access to the organization information processing apparatus 1, for example, except for the time specified with the setting information.

That is to say, the process that is performed by the setting information using processing unit 132 may be active processing such as transmission of information, or passive processing such as rejection of access from the terminal apparatus 2 or the like.

The output unit 14 outputs various types of information. In this example, the various types of information are, for example, notice to prompt a user to implement a survey, or information on a questionnaire. In this example, the output is typically transmission to the terminal apparatus 2, but may be regarded as a concept that encompasses display on a display screen, projection using a projector, printing by a printer, output of a sound, accumulation in a storage medium, delivery of a processing result to another processing apparatus or another program, and the like.

In the terminal storage unit 21 constituting the terminal apparatus 2, various types of information are stored. The various types of information are, for example, an organization identifier for identifying a user's organization. The various types of information are, for example, the information received by the terminal receiving unit 25. The organization identifier may be regarded as information for identifying a user. The organization identifier may be a user identifier that is used to identify an organization or the like.

The terminal accepting unit 22 accepts various types of instructions, information, or the like. The accepting is a concept that encompasses accepting information input from an input device such as a keyboard, a mouse, or a touch panel, receiving information transmitted via a wired or wireless communication line, accepting information read from a storage medium such as an optical disk, a magnetic disk, or a semiconductor memory and the like. That is to say, the various types of instructions, information, or the like may be input by any part such as a touch panel, a keyboard, a mouse, a menu screen, or the like.

Furthermore, various types of instructions, information, or the like are, for example, organization information, action information, questionnaire response information, proposal information, setting information, later-described input information, a start instruction, or the like.

The terminal processing unit 23 performs various types of processing. The various types of processing are, for example, a process that configures data that is to be displayed, from the information received by the terminal receiving unit 25. The various types of processing are, for example, a process that configures instructions or the like that is to be transmitted, from the instructions or the like accepted by the terminal accepting unit 22.

The terminal transmitting unit 24 transmits various types of instructions, information, or the like, to the organization information processing apparatus 1. The various types of instructions, information, or the like are, for example, the instructions configured by the terminal processing unit 23, or the instructions, information, or the like accepted by the terminal accepting unit 22.

The terminal receiving unit 25 receives various types of information. The terminal receiving unit 25 typically receives various types of information from the organization information processing apparatus 1. The various types of information are, for example, proposal information, setting information, notice to prompt a user to implement a survey, or information on a questionnaire.

The terminal output unit 26 acquires various types of information. The various types of information are, for example, the information accepted by the terminal accepting unit 22, the information received by the terminal receiving unit 25, or the information configured by the terminal processing unit 23. The various types of information are, for example, proposal information, setting information, notice to prompt a user to implement a survey or information on a questionnaire.

The storage unit 11, the organization information storage unit 111, the action information storage unit 112, the response information storage unit 113, the proposal information storage unit 114, the setting information storage unit 115, and the terminal storage unit 21 are preferably non-volatile storage media, but can also be realized by volatile storage media.

There is no limitation on the procedure in which information is stored in the storage unit 11 and the like. For example, information may be stored in the storage unit 11 and the like via a storage medium, information transmitted via a communication line or the like may be stored in the storage unit 11 and the like, or information input via an input device may be stored in the storage unit 11 and the like.

The accepting unit 12 and the terminal receiving unit 25 are typically realized by a wireless or wired communication part, but can also be realized by a broadcast receiving part.

The processing unit 13, the improvement processing unit 131, the setting information using processing unit 132, the proposal information acquiring part 1311, the setting information acquiring part 1313, the setting information output part 1314, and the terminal processing unit 23 realized typically by MPUs, memories, or the like. Typically, the processing procedure of the processing unit 13 and the like is realized by software, and the software is stored in a storage medium such as a ROM. Note that the processing procedure may be realized also by hardware (dedicated circuits).

The proposal information output part 1312, the output unit 14, and the terminal transmitting unit 24 are typically realized by a wireless or wired communication part, but can also be realized by a broadcasting part. The proposal information output part 1312, the output unit 14 may be realized by driver software for an output device, a combination of driver software for an output device and the output device, or the like.

The terminal output unit 26 may be considered to include or to not include an output device such as a display screen or a speaker. The terminal output unit 26 may be realized by driver software for an output device, a combination of driver software for an output device and the output device, or the like.

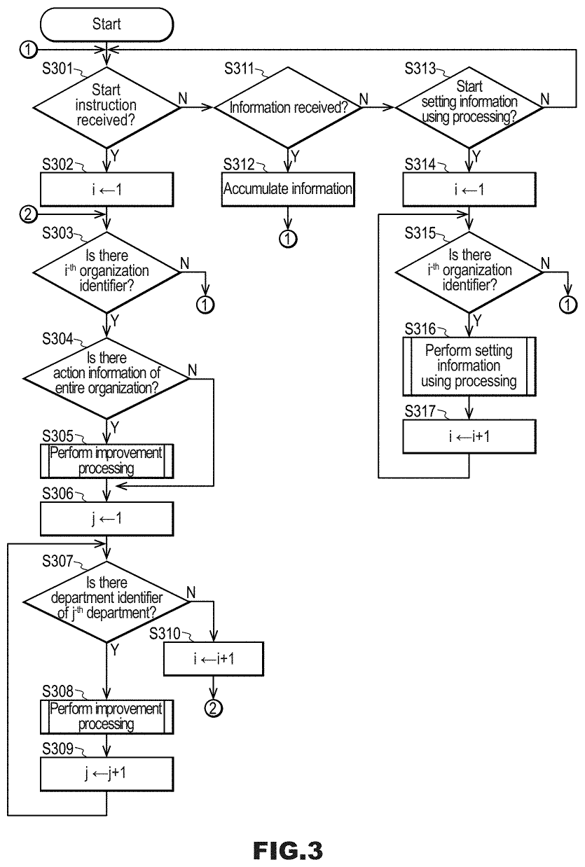

Next, an operation of the information system A will be described. First, an operation example of the organization information processing apparatus 1 will be described with reference to the flowchart in FIG. 3.

(Step S301) The accepting unit 12 judges whether or not it has received a start instruction from the terminal apparatus 2. If it has received a start instruction, the procedure advances to step S302, and, if otherwise, the procedure advances to step S311.

(Step S302) The improvement processing unit 131 substitutes 1 for a counter i.

(Step S303) The improvement processing unit 131 judges whether or not there is an i^{-th} organization identifier. If there is an i^{-th} organization identifier, the procedure advances to step S304, and, if otherwise, the procedure returns to step S301.

(Step S304) The improvement processing unit 131 judges whether or not there is action information of the entire organization corresponding to the i^{-th} organization identifier, in the action information storage unit 112. If there is action information of the entire organization, the procedure advances to step S305, and, if otherwise, the procedure advances to step S306.

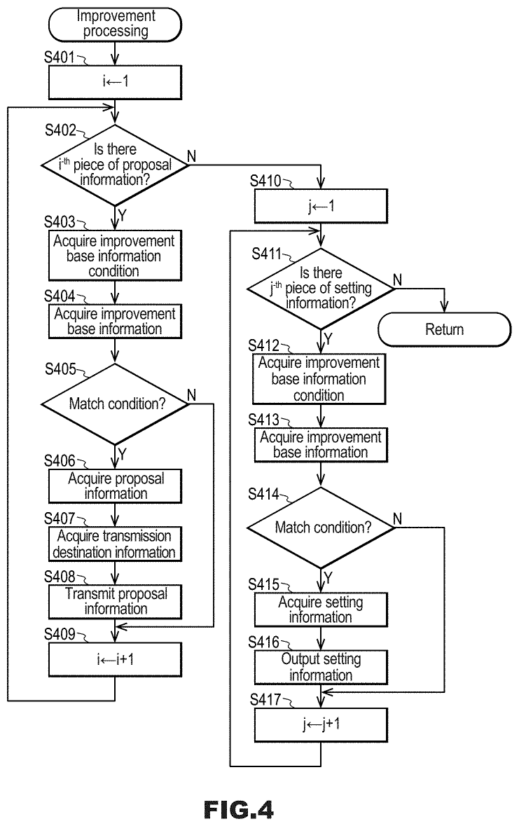

(Step S305) The improvement processing unit 131 performs improvement processing on the entire organization corresponding to the i^{-th} organization identifier. An example of the improvement processing will be described with reference to the flowchart in FIG. 4.

(Step S306) The improvement processing unit 131 substitutes 1 for a counter j.

(Step S307) The improvement processing unit 131 judges whether or not there is a department identifier of a j^{-th} department corresponding to the organization identifier, in the organization information storage unit 111. If there is the department identifier, the procedure advances to step S308, and, if otherwise, the procedure advances to step S310.

(Step S308) The improvement processing unit 131 performs improvement processing on the j^{-th} department corresponding to the i^{-th} organization identifier. An example of the improvement processing will be described with reference to the flowchart in FIG. 4.

(Step S309) The improvement processing unit 131 increments the counter j by 1. The procedure returns to step S307.

(Step S310) The improvement processing unit 131 increments the counter i by 1. The procedure returns to step S303.

(Step S311) The accepting unit 12 judges whether or not it has received information from the terminal apparatus 2. If it has received information, the procedure advances to step S312, and, if otherwise, the procedure advances to step S313. The information is, for example, organization information, action information, questionnaire response information, proposal information, setting information, or input information. The accepting unit 12 typically receives information associated with an organization identifier.

(Step S312) The processing unit 13 accumulates the information received in step S311 in the storage unit 11 in association with the organization identifier. The procedure returns to step S301.

(Step S313) The processing unit 13 judges whether or not it is time to start setting information using processing. If it is time to start setting information using processing, the procedure advances to step S314, and, if otherwise, the procedure returns to step S301. The time to start setting information using processing is, for example, that it is predetermined time, an instruction to start setting information using processing is received, or the like.

(Step S314) The setting information using processing unit 132 substitutes 1 for a counter i.

(Step S315) The setting information using processing unit 132 judges whether or not there is an i^{-th} organization identifier. If there is an i^{-th} organization identifier, the procedure advances to step S316, and, if otherwise, the procedure returns to step S301.

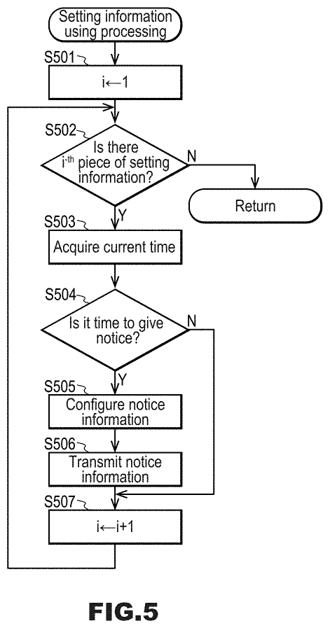

(Step S316) The setting information using processing unit 132 performs setting information using processing. An example of the setting information using processing will be described with reference to the flowchart in FIG. 5.

(Step S317) The setting information using processing unit 132 increments the counter i by 1. The procedure returns to step S315.

In the flowchart in FIG. 3, if the start instruction received in step S301 contains information for specifying an organization, typically, the processes from steps S304 to S310 are performed only on one or more organizations specified with the information for specifying an organization.

Furthermore, it is also possible that, in the flowchart in FIG. 3, the setting information using processing in step S316 is performed only on a specific organization.

In the flowchart shown in FIG. 3, processing ends at power off or at an interruption of ending processing.

Next, an example of the improvement processing in step S305 will be described with reference to the flowchart in FIG. 4.

(Step S401) The improvement processing unit 131 substitutes 1 for a counter i.

(Step S402) The improvement processing unit 131 judges whether or not there is an i^{-th} piece of proposal information, in the proposal information storage unit 114. If there is an i^{-th} piece of proposal information, the procedure advances to step S403, and, if otherwise, the procedure advances to step S410.

(Step S403) The proposal information acquiring part 1311 acquires improvement base information condition corresponding to the i^{-th} piece of proposal information, from the proposal information storage unit 114.

(Step S404) The proposal information acquiring part 1311 acquires information that is used by the improvement base information condition acquired in step S403, and that is paired with an organization identifier or a department identifier of an organization or a department of interest. This information is, for example, one or at least two types of information of the action information, the response information, and the organization attribute value.

Then, the proposal information acquiring part 1311 configures improvement base information, using the acquired information. It will be appreciated that there is no limitation on the data structure of the improvement base information.

(Step S405) The proposal information acquiring part 1311 judges whether or not the improvement base information acquired in step S404 matches the improvement base information condition acquired in step S403. If the information match each other, the procedure advances to step S406, and, if otherwise, the procedure advances to step S409.

(Step S406) The proposal information acquiring part 1311 acquires an i^{-th} piece of proposal information.

(Step S407) The proposal information output part 1312 acquires transmission destination information for specifying a transmission destination to which the proposal information is to be transmitted. The transmission destination information is information (e.g., an IP address, an e-mail address, etc.) for communicating with a terminal apparatus 2 from which the start instruction was transmitted, or transmission destination information (e.g., e-mail address, a telephone number, etc.) stored in the storage unit 11 so as to be paired with an organization identifier or a department identifier of an organization or a department of interest.

(Step S408) The proposal information output part 1312 transmits the proposal information acquired in step S406, to a transmission destination indicated by the transmission destination information acquired in step S407.

(Step S409) The improvement processing unit 131 increments the counter i by 1. The procedure returns to step S402.

(Step S410) The improvement processing unit 131 substitutes 1 for a counter j.

(Step S411) The improvement processing unit 131 judges whether or not there is a j^{-th} piece of setting information, in the setting information storage unit 115. If there is a j^{-th} piece of setting information, the procedure advances to step S412, and, if otherwise, the procedure returns to the upper-level processing.

(Step S412) The setting information acquiring part 1313 acquires an improvement base information condition corresponding to the j^{-th} piece of setting information, from the setting information storage unit 115.

(Step S413) The setting information acquiring part 1313 acquires information that is used by the improvement base information condition acquired in step S412, and that is paired with an organization identifier or a department identifier of an organization or a department of interest. This information is, for example, one or at least two types of information of the action information, the response information, and the organization attribute value.

Then, the setting information acquiring part 1313 configures improvement base information, using the acquired information.

(Step S414) The setting information acquiring part 1313 judges whether or not the improvement base information acquired in step S413 matches the improvement base information condition acquired in step S412. If the information match each other, the procedure advances to step S415, and, if otherwise, the procedure advances to step S417.

(Step S415) The setting information acquiring part 1313 acquires a j^{-th} piece of setting information.

(Step S416) The setting information output part 1314 outputs the j^{-th} piece of setting information acquired in step S415. In this example, the output is, for example, accumulation in the organization information storage unit 111.

(Step S417) The improvement processing unit 131 increments the counter j by 1. The procedure returns to step S411.

Next, an example of the setting information using processing in step S316 will be described with reference to the flowchart in FIG. 5.

(Step S501) The setting information using processing unit 132 substitutes 1 for a counter i.

(Step S502) The setting information using processing unit 132 judges whether or not there is an i^{-th} piece of setting information. If there is an i^{-th} piece of setting information, the procedure advances to step S503, and, if otherwise, the procedure returns to the upper-level processing.

(Step S503) The setting information using processing unit 132 acquires a current time from an unshown clock, an unshown NTP server, or the like.

(Step S504) The setting information using processing unit 132 judges whether or not it is time to give notice, using the current time acquired in step S503 and the i^{-th} piece of setting information. If it is time to give notice, the procedure advances to step S505, and, if otherwise, the procedure advances to step S507.

(Step S505) The setting information using processing unit 132 configures notice information, which is information that is to be given as notice. The process that configures notice information may be a process that reads the notice information from the storage unit 11. The setting information using processing unit 132 configures notice information, for example, using the i^{-th} piece of setting information. The notice information is, for example, “Please implement a focus survey”, “The focus survey implementation time has already passed.”, or the like.

(Step S506) The setting information using processing unit 132 transmits the notice information acquired in step S505 to the terminal apparatus 2.

(Step S507) The setting information using processing unit 132 increments the counter i by 1. The procedure returns to step S502.

Next, an operation of the terminal apparatus 2 will be described. The terminal accepting unit 22 of the terminal apparatus 2 accepts various types of instructions, information, or the like. Next, the terminal processing unit 23 configures instructions or the like that is to be transmitted, from the instructions or the like accepted by the terminal accepting unit 22. The terminal transmitting unit 24 transmits the instructions or the like configured by the terminal processing unit 23, to the organization information processing apparatus 1. Then, in response to transmission of the instructions or the like, the terminal receiving unit 25 receives information from the organization information processing apparatus 1. Next, the terminal processing unit 23 configures data that is output, from the information received by the terminal receiving unit 25. Next, the terminal output unit 26 outputs the information configured by the terminal processing unit 23.

Hereinafter, a specific operation of the information system A in this embodiment will be described. FIG. 1 is a conceptual diagram of the information system A.

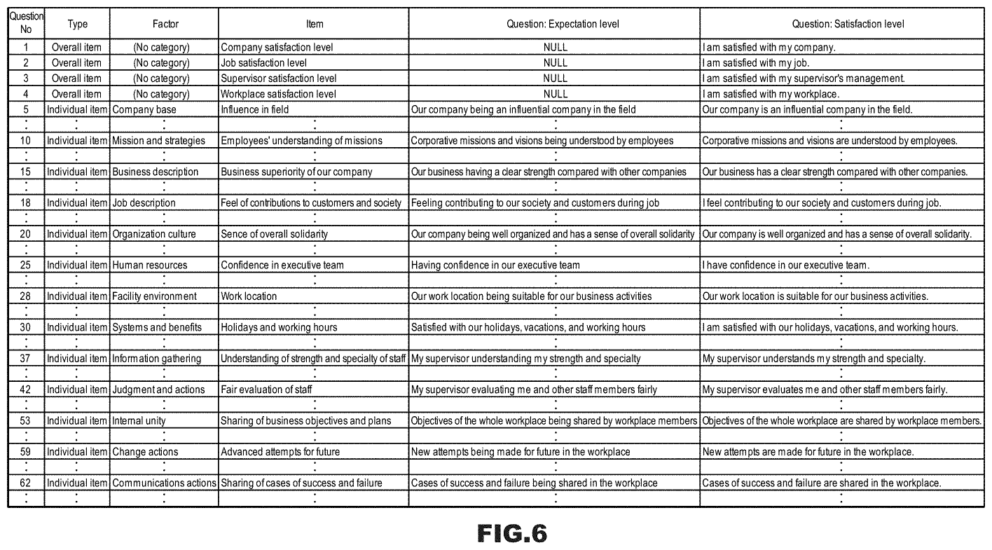

It is assumed that, for example, an item information management table shown in FIG. 6 is stored in the storage unit 11. The item information management table is a table for managing a large number of pieces of item information each indicating an item of a questionnaire to a member (an employee in this example) of an organization (a company in this example). The item information in this example has “question No”, “type”, “factor”, “item”, “question: expectation level”, and “question: satisfaction level”. “Question No” is an ID for identifying a question, and is an example of an item identifier. “Type” is information indicating the type of item, and, in this example, may be either an overall item or an individual item. “Factor” is a middle concept of an item, and may also be said to be an object. “Item” is information indicating the content of an item. “Item” may be regarded as an item identifier. “Question: expectation level” is a question for acquiring expectation level information. “Question: satisfaction level” is a question for acquiring satisfaction level information. Questions paired with items stored in the item information management table constitutes a questionnaire, and the questionnaire is transmitted to a terminal apparatus 2 of an organization member. As described above, a questionnaire having both an overall item and an individual item is used for an engagement survey. A questionnaire having only an overall item is used for a focus survey.

It is assumed that, in FIG. 6, records with the question Nos “1” to “4” are associated with the questionnaire type “focus survey”. Furthermore, it is assumed that, in FIG. 6, records with the question Nos “5” and thereafter are associated with the questionnaire type “organization diagnosis”. It is also possible that records with the question Nos “1” to “4” are also associated with the questionnaire type “focus survey”.

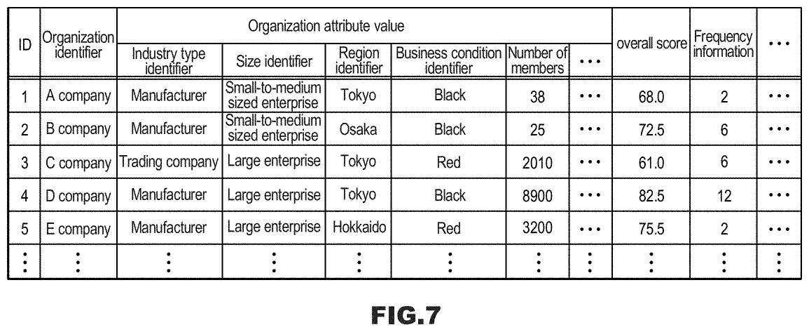

Furthermore, for example, an organization information management table shown in FIG. 7 is stored in the organization information storage unit 111. The organization information management table is a table for managing organization information. The organization information management table has two or more records each having “ID”, “organization identifier”, “Organization attribute value”, “Overall score”, “Frequency information”, and the like. “Organization attribute value” in this example has “industry type identifier”, “size identifier”, “region identifier”, “business conditions identifier”, “the number of members”, and the like. “Industry type identifier” is information for identifying an industry type, in this example, such as manufacturer, trading company, bank, or the like. “Size identifier” is information for identifying a size of an organization, such as large enterprise, small-to-medium sized enterprise, micro enterprise, self-employed, or the like. “Region identifier” is information for identifying a location of a home office of an organization (company, etc.), such as any one of the prefectures. “Business conditions identifier” is information for identifying a business condition, such as being the black or the red, or the like. “The number of members” is the number of organization members (e.g., the number of company members). “Overall score” is an organization overall score calculated by the processing unit 13. The overall score may be either an absolute overall score or a relative overall score. “Frequency information” in this example is information indicating an implementation frequency of a focus survey, wherein “2” indicates that a focus survey is implemented twice per year. It will be appreciated that “frequency information” may also be “12” (once/month) or the like.

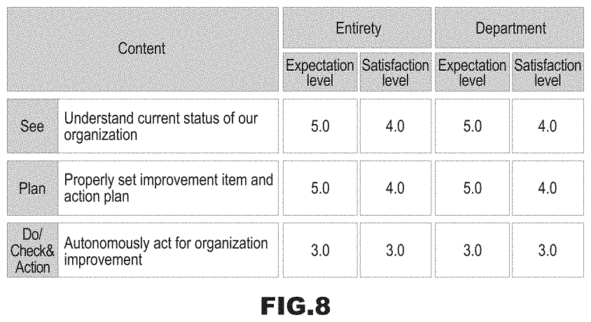

Furthermore, in the action information storage unit 112, for example, action information shown in FIG. 8 is stored. The action information shown in FIG. 8 is action information with the organization identifier “A company”. It is assumed that, typically, action information of two or more organizations is stored in the action information storage unit 112. The action information in FIG. 8 contains information on the expectation level and the satisfaction level of the entire A company and the expectation level and the satisfaction level of one department in three phases “See”, “Plan”, and “Do/Check-Action”. The action information in FIG. 8 is, for example, information that is input by a user to the terminal apparatus 2, received by the organization information processing apparatus 1, and accumulated in the action information storage unit 112.

It is assumed that a flag indicating whether or not to implement a focus survey (which is referred to as a focus survey flag) and a flag indicating whether or not to implement an action plan (which is referred to as an action plan flag) are stored in the action information storage unit 112 in association with an organization identifier. It is assumed that, for example, “focus survey flag=1” and “an action plan flag=1” are stored in the action information storage unit 112 so as to be paired with the organization identifier “A company”. It is assumed that, in the case of implementing a focus survey, “focus survey flag=1”, and, in the case of not implementing a focus survey, “focus survey flag=0”. Also, it is assumed that, in the case of implementing an action plan, “an action plan flag=1”, and, in the case of not implementing an action plan, “an action plan flag=0”.

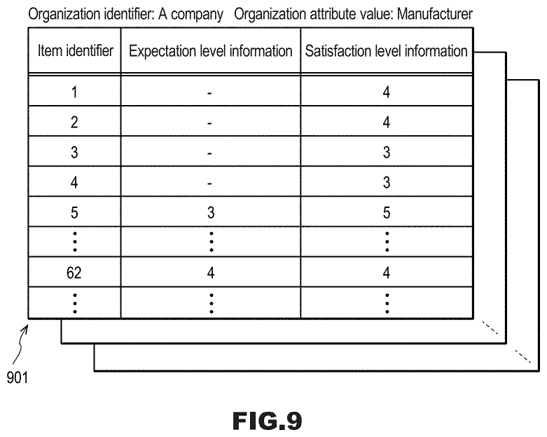

Furthermore, it is assumed that response information having, for example, a structure as shown in FIG. 9 is stored in the response information storage unit 113. Typically two or more pieces of response information are stored in the response information storage unit 113. FIG. 9 shows response information of an organization identified with the organization identifier “A company”. 901 denotes member response information of one employee of the organization identified with the organization identifier “A company”. The response information of an organization identified with the organization identifier “A company” contains member response information of two or more employees. The member response information has a large number of (63 or more in this example) records each having “item identifier”, “expectation level information”, and “satisfaction level information”. The record of an item with an item identifier of 1 to 4 is a record of an overall item, and has no expectation level information. Then, the expectation level information and the satisfaction level information constituting the member response information of 901 are information acquired from responses of an employee to “question: expectation level” and “question: satisfaction level” of the item information management table shown in FIG. 7. This responses in this example are responses indicated by a natural number of 1 to 5. In this example, if the expectation level information to “question: expectation level” is 1, the expectation level is lowest, and, if the expectation level information is 5, the expectation level is highest. If the satisfaction level information to “Question: satisfaction level” is 1, the satisfaction level is lowest, and, if the satisfaction level information is 5, the satisfaction level is highest. Furthermore, it is assumed that the organization attribute value indicating the industry type of the organization identified with the organization identifier “A company” is “manufacturer”. The industry type is an example of the organization attribute. It is assumed that multiple pieces of response information of organizations corresponding to the organization attribute value “manufacturer” are stored in the response information storage unit 113.

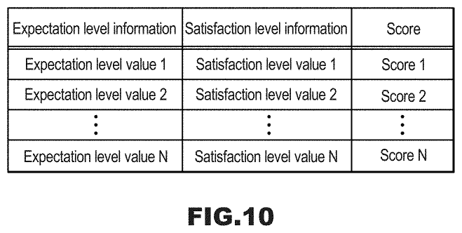

Furthermore, an individual score table shown in FIG. 10 is stored in the storage unit 11. In the individual score table, two or more records each having “expectation level information”, “satisfaction level information”, and “score” are managed. “Expectation level information” is, for example, an average value of the expectation level information. “Expectation level information” may be, for example, information indicating the range of an average value of the expectation level information. “Expectation level value 1”, “expectation level value 2” . . . , and “expectation level value N”, which are attribute values of “expectation level information”, are information indicating specific values or ranges. “Satisfaction level information” is, for example, an average value of the satisfaction level information. “Satisfaction level information” may be, for example, information indicating the range of an average value of the satisfaction level information. “Satisfaction level value 1”, “satisfaction level value 2” . . . , and “satisfaction level value N”, which are attribute values of “satisfaction level information”, are information indicating specific values or ranges. “Score” in this example is information indicating an item score. “Score 1”, “score 2” . . . , and “score N”, which are attribute values of “score”, are specific values. The processing unit 13 applies, for example, the statistical satisfaction level information and the statistical expectation level information contained in the response information, to the individual score table in FIG. 10, thereby acquiring an absolute item score of each individual item. Then, the processing unit 13 accumulates the acquired item score in a buffer so as to be paired with the item identifier of each individual item. Then, the processing unit 13 performs statistical processing on the acquired item score, thereby calculating an overall score. This overall score is an attribute value of “overall score” in FIG. 7.

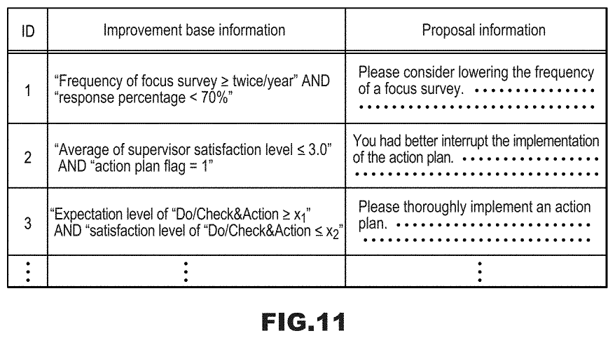

Furthermore, a proposal information management table shown in FIG. 11 is stored in the proposal information storage unit 114. The proposal information management table has one or more records each having “ID”, “improvement base information condition”, and “proposal information”. In the proposal information management table shown in FIG. 11, the improvement base information condition with “ID=1” is that “the frequency of a focus survey is twice or more per year, and the response percentage of members to the focus survey is less than 70%”. The improvement base information condition with “ID=2” is the “the average value of the supervisor satisfaction level in a focus survey is 3.0 or less, and an action plan is implemented”. The improvement base information condition with “ID=3” is that “the expectation level of “Do/Check&Action” is x₁ or more, and the satisfaction level of “Do/Check&Action” is x₂ or less. In the improvement base information condition with “ID=3”, “x₁>x₂” is preferable.

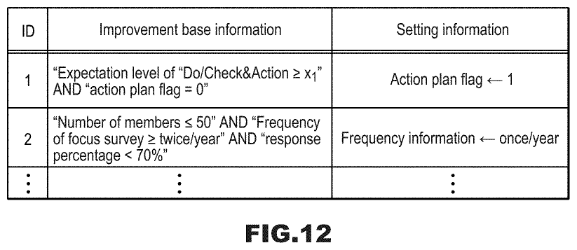

Moreover, a setting information management table shown in FIG. 12 is stored in the setting information storage unit 115. The setting information management table has one or more records each having “ID”, “improvement base information condition”, and “setting information”. In FIG. 12, the improvement base information condition with “ID=1” is that “the expectation level of “Do/Check&Action” is x₁ or more, and an action plan is not implemented”. The improvement base information condition with “ID=2” is that “the number of organization member is 50 or less, the frequency of a focus survey is twice or more per year, response percentage is less than 70%”.

In this situation, it is assumed that the user inputs a start instruction containing “organization identifier=“A company”” to the terminal apparatus 2. Then, the terminal accepting unit 22 of the terminal apparatus 2 accepts the start instruction containing “organization identifier=“A company””. Next, the terminal processing unit 23 configures a start instruction that is to be transmitted, from the start instruction accepted by the terminal accepting unit 22. The terminal transmitting unit 24 transmits the start instruction configured by the terminal processing unit 23, to the organization information processing apparatus 1.

Next, the accepting unit 12 of the organization information processing apparatus 1 receives the start instruction from the terminal apparatus 2.

Next, the improvement processing unit 131 acquires an organization identifier “A company” contained in the start instruction. Next, the improvement processing unit 131 performs improvement processing as follows.

That is to say, the improvement processing unit 131 acquires an organization attribute value paired with the organization identifier “A company”, from the organization information management table in FIG. 7. The improvement processing unit 131 acquires action information (see FIG. 8) paired with the organization identifier “A company”, from the action information storage unit 112. It is assumed that the action information in this example contains “focus survey flag=1” and “an action plan flag=1” paired with the organization identifier “A company”. The improvement processing unit 131 acquires response information (see FIG. 9) paired with the organization identifier “A company”, from the response information storage unit 113.

Next, the improvement processing unit 131 judges whether or not the information that is acquired and is paired with the organization identifier “A company” matches the improvement base information condition of each record in FIG. 11. In this example, it is assumed that the improvement processing unit 131 acquires a questionnaire response percentage “55%” of the organization “A company”, and judges that the information matches the improvement base information conditions of the records with “ID=1” and “ID=2” in FIG. 11. The process that acquires a response percentage “55%” from response information of one or more members and the number of members, which is an organization attribute value, is a known technique, and thus a detailed description thereof has been omitted.

It is assumed that the improvement processing unit 131 acquires proposal information “Please consider lowering the frequency of a focus survey. . . . ”, “You had better interrupt the implementation of the action plan. . . . ” with “ID=1” and “ID=2”.

Next, the improvement processing unit 131 transmits the acquired proposal information, to a transmission destination (in this example, for example, the terminal apparatus 2) indicated by the transmission destination information paired with the organization identifier “A company”.

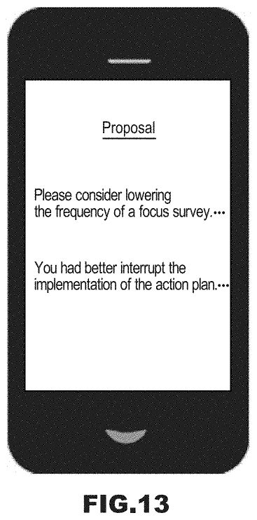

Next, in response to transmission of the start instruction, the terminal receiving unit 25 of the terminal apparatus 2 receives the proposal information from the organization information processing apparatus 1. Next, the terminal processing unit 23 configures data that is output, from the proposal information received by the terminal receiving unit 25. Next, the terminal output unit 26 outputs the proposal information configured by the terminal processing unit 23. FIG. 13 shows an example of the output.

Furthermore, the improvement processing unit 131 judges whether or not the information that is acquired and is paired with the organization identifier “A company” matches the improvement base information condition of each record in FIG. 12. In this example, it is assumed that the improvement processing unit 131 judges that the information matches the improvement base information condition of the record with “ID=2” in FIG. 12. Then, the improvement processing unit 131 outputs frequency information “once/year” that is setting information paired with the organization identifier “A company”. In this example, for example, the improvement processing unit 131 rewrites the frequency information paired with the organization identifier “A company” to “once/year”.

The improvement processing unit 131 may transmit information indicating that the frequency information has been rewritten to “once/year”, to a transmission destination (in this example, for example, the terminal apparatus 2) indicated by the transmission destination information paired with the organization identifier “A company”.

As described above, according to this embodiment, it is possible to provide processing for properly operating an organization improvement system, using one or more scores of each of the two or more phases constituting an action for an organization improvement.

The processing in this embodiment may be realized by software. The software may be distributed by software downloads or the like. Furthermore, the software may be distributed in a form where the software is stored in a storage medium such as a CD-ROM. Note that the same is applied to other embodiments described in this specification. The software that realizes the organization information processing apparatus 1 in this embodiment is the following sort of program. Specifically, this program is a program for causing a computer capable of accessing an action information storage unit in which one or more pieces of action information containing one or more scores regarding each of two or more phases constituting an action for an organization improvement are stored, to function as: an improvement processing unit that acquires one or more scores contained in each of the two or more phases from the action information storage unit, and performs improvement processing, which is processing for an organization improvement, using improvement base information having one or more scores of each of the two or more phases.

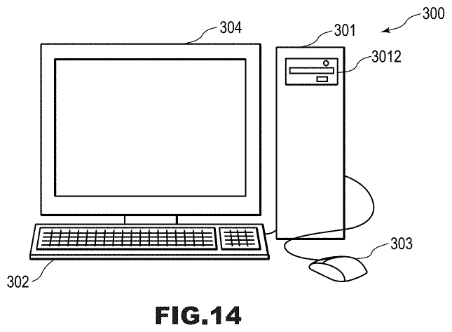

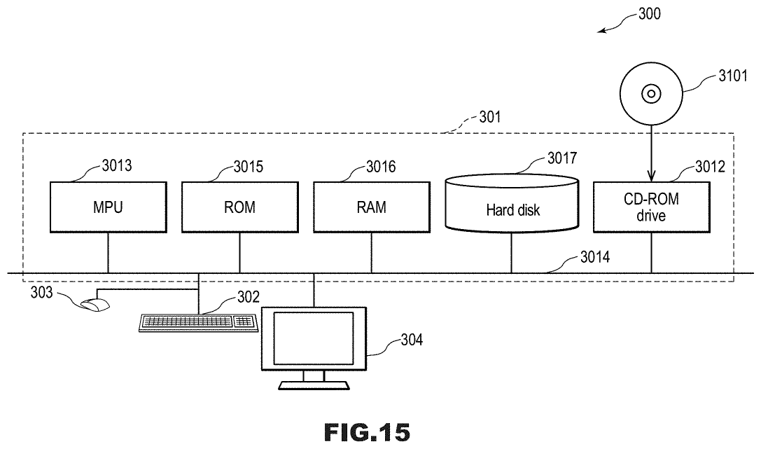

FIG. 14 shows the external appearance of a computer that executes the program described in this specification to realize the organization information processing apparatus 1 and the like in the foregoing various embodiments. The foregoing embodiments may be realized using computer hardware and a computer program executed thereon. FIG. 14 is a schematic view of a computer system 300. FIG. 15 is a block diagram of the system 300. FIGS. 14 and 15 show the external appearance and the like of a computer that realizes the engagement system.

In FIG. 14, the computer system 300 includes a computer 301 including a CD-ROM drive 3012, a keyboard 302, a mouse 303, and a monitor 304.

In FIG. 15, the computer 301 includes, in addition to the CD-ROM drive 3012, an MPU 3013, a bus 3014 connected to the CD-ROM drive 3012 and the like, a ROM 3015 in which a program such as a boot up program is stored, a RAM 3016 that is connected to the MPU 3013 and is a memory in which a command of an application program is temporarily stored and a temporary storage area is provided, and a hard disk 3017 in which an application program, a system program, and data are stored. Although not shown, the computer 301 may further include a network card that provides connection to a LAN.

The program for causing the computer system 300 to execute the functions of the organization information processing apparatus 1 and the like in the foregoing embodiments may be stored in a CD-ROM 3101 that is inserted into the CD-ROM drive 3012, and be transmitted to the hard disk 3017. Alternatively, the program may be transmitted via a network (not shown) to the computer 301 and stored in the hard disk 3017. At the time of execution, the program is loaded into the RAM 3016. The program may be loaded from the CD-ROM 3101, or directly from a network.

The program does not necessarily have to include, for example, an operating system (OS) or a third party program to cause the computer 301 to execute the functions of the organization information processing apparatus 1 and the like in the foregoing embodiments. The program may only include a command portion to call an appropriate function (module) in a controlled mode and obtain desired results. The manner in which the computer system 300 operates is well known, and thus a detailed description thereof has been omitted.

It should be noted that, in the program, in a step of transmitting information, a step of receiving information, or the like, processing that is performed by hardware, for example, processing performed by a modem or an interface card in the transmitting step (processing that can be performed only by hardware) is not included.

Furthermore, the computer that executes the program may be a single computer, or may be multiple computers. That is to say, centralized processing may be performed, or distributed processing may be performed.

Furthermore, in the foregoing embodiments, it will be appreciated that two or more communication parts in one apparatus may be physically realized by one medium.

In the foregoing embodiments, each process may be realized as centralized processing using a single apparatus, or may be realized as distributed processing using multiple apparatuses.

The present invention is not limited to the embodiment set forth herein. Various modifications are possible within the scope of the present invention.

As described above, the organization information processing apparatus according to the present invention has the effect of making it possible to provide processing for properly operating an organization improvement system, and thus this apparatus is useful as an organization information processing apparatus and the like.

What is claimed is:

1. An organization information processing apparatus comprising:
an action information storage unit in which one or more pieces of action information containing one or more scores regarding each of two or more phases constituting an action for an organization improvement are stored; and
an improvement processing unit that performs improvement processing, which is processing for an organization improvement, using improvement base information specified from one or more scores of one or more phases among the two or more phases.

2. The organization information processing apparatus according to claim 1, further comprising:
a response information storage unit in which two or more pieces of response information indicating a response of each of two or more members of the organization to a questionnaire are stored,
wherein the improvement processing unit performs processing for an organization improvement, using improvement base information specified from the one or more scores of each of the one or more phases stored in the action information storage unit and the two or more pieces of response information stored in the response information storage unit.

3. The organization information processing apparatus according to claim 1,
wherein the action information has two or more pieces of phase information, which is information in each of the two or more phases, and
the phase information has one or more scores and input-related information regarding input in a phase.

4. The organization information processing apparatus according to claim 3, wherein the input-related information is one or more types of information, out of input information input to the phase and input amount information regarding the amount of the input information.

5. The organization information processing apparatus according to claim 1,
wherein the one or more pieces of action information in the action information storage unit respectively correspond to organization attribute values, each of which is an attribute value of the organization, and
the improvement processing unit performs different types of processing for an organization improvement, according to the organization attribute values, even in a case of using same improvement base information.

6. The organization information processing apparatus according to claim 1, wherein the action information contains a score of one or more of the expectation level and the satisfaction level for each phase.

7. The organization information processing apparatus according to claim 1, further comprising:
a proposal information storage unit in which each of two or more pieces of proposal information indicating a proposal regarding an operation of an organization improvement system, which is a system for an organization improvement, is stored in association with an improvement base information condition, which is a condition regarding improvement base information containing one or more scores of any one or more phases,
wherein the improvement processing unit includes:
a proposal information acquiring part that acquires proposal information paired with an improvement base information condition matching the improvement base information, from the proposal information storage unit; and
a proposal information output part that outputs the proposal information acquired by the proposal information acquiring part.

8. The organization information processing apparatus according to claim 1, further comprising:
a setting information storage unit in which one or more pieces of setting information, which is information that is used by an organization improvement system, are stored in association with an improvement base information condition, which is a condition regarding improvement base information containing one or more scores of any one or more phases,
wherein the improvement processing unit includes:
a setting information acquiring part that acquires setting information paired with an improvement base information condition matching the improvement base information, from the setting information storage unit; and
a setting information output part that outputs the setting information acquired by the setting information acquiring part.

9. The organization information processing apparatus according to claim 1,
wherein, in the action information storage unit, action information is stored for each organization, and action information of the entire organization and action information of each of two or more departments, in each of at least one or more organizations, are stored, and
the improvement processing unit acquires one or more scores contained in the action information of the entire organization and performs processing for an organization improvement using improvement base information having the one or more scores, and acquires one or more scores contained in the action information of each of the two or more departments and performs processing for an organization improvement using improvement base information having the one or more scores.

10. An organization information processing method realized using an action information storage unit in which one or more pieces of action information containing one or more scores regarding each of two or more phases constituting an action for an organization improvement are stored, and an improvement processing unit, comprising:
a first step of the improvement processing unit acquiring one or more scores contained in each of the two or more phases from the action information storage unit; and
a second step of the improvement processing unit performing improvement processing, which is processing for an organization improvement, using improvement base information having one or more scores of each of the two or more phases.

11. A storage medium on which a program is stored, the program causing a computer capable of accessing an action information storage unit in which one or more pieces of action information containing one or more scores regarding each of two or more phases constituting an action for an organization improvement are stored, to function as:
an improvement processing unit that acquires one or more scores contained in each of the two or more phases from the action information storage unit, and performs improvement processing, which is processing for an organization improvement, using improvement base information having one or more scores of each of the two or more phases.
